(19) United States
(12) Patent Application Publication
(10) Pub. No.: US 2009/0106868 A1
(43) Pub. Date: Apr. 23, 2009

(54) ATOMIC FORCE MICROSCOPE TIP SHAPE DETERMINATION TOOL

(75) Inventors: Johann Foucher, Meylan (FR); Stefan Landis, Voiron (FR)

Correspondence Address: LOWE HAUPTMAN & BERNER, LLP, 1700 DIAGONAL ROAD, SUITE 300, ALEXANDRIA, VA, 22314, US

(73) Assignee: COMMISSARIAT A L'ENRGIE ATOMIQUE, Paris (FR)

(21) Appl. No.: 12/096,953

(22) PCT Filed: Dec. 4, 2006
(86) PCT No.: PCT/EP2006/069249

§ 371 Date: Nov. 20, 2008

(30) Foreign Application Priority Data
Dec. 13, 2005 (FR) 05 12607

(51) Int. Cl. G01N 13/16

(52) U.S. Cl. 850/8

(57) ABSTRACT

The invention relates to an atomic force microscope tip characterization tool. An atomic force microscope uses a very fine exploration tip placed at the end of an elastic cantilever beam and an optical system for exploring movements of the beam in contact with a relief to be explored. The shape of the exploration tip must be known, and to this end a tool is used, placed in an atomic force microscope, the known shapes whereof are used to derive the shape of the tip. The tool of the invention includes a thin silicon beam (50) placed between two separated studs, formed on a support plate. The tip to be measured is moved between the studs remaining in contact with the beam and the measurement of the position of the tip during these movements enables the shape of the tip to be derived. The very small thickness (less than 5 nm) of the beam allows great accuracy and great reproducibility of measurement.

### CROSS-REFERENCE TO RELATED APPLICATIONS

The present application is based on International Application No. PCT/EP2006/069249, filed on Dec. 4, 2006 which in turn corresponds to French Application No. 0512607, filed on Dec. 13, 2005, and priority is hereby claimed under 35 USC §119 based on these applications. Each of these applications are hereby incorporated by reference in their entirety into the present application.

### FIELD OF THE INVENTION

The invention concerns a tool for characterization of atomic force microscope tips.

### BACKGROUND OF THE INVENTION

An atomic force microscope uses a very fine exploration tip, of ceramic or of semiconductor material, for example placed at the end of an elastic cantilever beam somewhat like twentieth century gramophone styli. The tip is moved over a surface to be explored and the deflection movements of the beam generated by the relief of the explored surface during the course of the movements are recorded. The amplitude of the deflection of the beam is generally detected by an optical system that considerably amplifies the deflection; such optical systems typically comprise a laser diode that illuminates a reflective surface of the beam at an oblique incidence and a detector sensitive to the position of the reflected beam that it receives and therefore capable of detecting modifications of the orientation of the light beam caused by the deflection of the beam. An atomic force microscope typically measures relief heights with a resolution of 0.01 nanometre in height and approximately 5 nanometres in the plane of the explored surface.

The tips conventionally have conical or pyramidal shapes, like gramophone styli used to have. However, it is clear that this type of tip can explore only reliefs without overhangs (such as hill and dale shapes). It cannot explore reliefs with overhangs.

Tips with complex shapes known as AFM-3D tips have therefore been designed for measuring dimensions of complex reliefs and notably reliefs including overhangs.

FIG. 1 represents by way of simple example, on the left (1a) the principle of exploration of a relief with no overhang by a simple conical or pyramidal tip, in the middle (1b) the difficulty arising from exploring a shape with cavities or overhangs using that tip, which cannot contact areas below overhangs, and on the right (1c) the principle of exploring a relief with overhangs using an AFM-3D tip of more complex shape (elephant's foot shape, sufficiently flared to contact the relief under the overhang).

For simple tips as well as for complex tips, the problem arises of knowing the exact shape and the real dimensions of the tip. Lacking such knowledge, the relief that is observed by means of the tip cannot be determined exactly. As shown in FIG. 2 for a simple tip, assuming that a conical tip encounters a cylindrical hole with vertical walls and a flat bottom (2a), observation of the movements of the tip (observation curve 2b) typically suggests that the shape of the hole is frustoconical, and not cylindrical. The shape of the curve observed is in fact not the shape of the hole but of a convolution of the shape of the tip and the shape of the hole. Only deconvolution, using the knowledge of the exact shape of the tip, enables the real relief (2c) to be reconstituted. Hence the importance of this knowledge of the shape of the tip.

The problem is even more critical for complex tips, and determining the shape and the dimensions of such tips is much more difficult. It is nevertheless crucial for the accuracy and reproducibility of the measurements.

To calibrate complex tips, two different silicon characterization structures can be used in succession, one for determining the overall diameter of the tip, the other for determining the shape. The first characterization structure, shown diagrammatically in FIG. 3, simply consists of a silicon wall (or line) of known width L1, with relatively smooth vertical flanks, upstanding from a silicon surface. The tip 10 of complex shape, with two laterally projecting points 12 and 14, is moved relative to the wall 20 (FIG. 3a), pressing on the left-hand flank, the top, and the right-hand flank in succession. The movement contour (FIG. 3b) traced out by the tip is a rectangle whose width L is not L1 but L1+L2, if L2 is the width of the tip, i.e. the distance that separates the two lateral points 12 and 14 from each other. This is simply because the right-hand point 14 presses on the left-hand flank of the wall 20 whereas the left-hand point 12 bears on the right-hand flank. Thus the width L of the contour is measured and the width L2=L−L1 can be deduced from it when L1 is known.

A second characterization structure, in the form of a cavity, can then be used to determine and to quantify more precisely the shapes of the tip on each of its sides. The cavity 30 (FIG. 4) is recessed into a silicon plate (for example) and has known dimensions and shapes. The shape of the cavity is such that all points on the tip 10 can be in contact at any given time with a wall of the cavity at only one point. This dictates the shape chosen for the cavity, with overhangs 32 and 34 of slightly rising shape made thinner at the top to have low radii of curvature, less than 10 nanometres. The points of contact between the tip and the structure can then be considered as virtually point contacts. The contour followed by the tip when it moves makes it possible to work back to the shape of the tip (by deconvolution with the shape of the cavity and its overhangs). The shape is reconstituted by determining a succession of coordinates (x, z) of the points of contact as the tip moves in the cavity, and it is the curve of that succession that is the subject of deconvolution. The sampling of the contour measurements must be sufficient (at least one point per nanometre) to ensure sufficient reconstitution accuracy.

The drawback of this characterization method is that it necessitates two different characterization structures and the uncertainty in respect of the shape measurement is the sum of the uncertainties linked to each of the structures.

Another drawback is that the silicon cavity is not easy to produce, especially the rising overhangs, which can be difficult to produce with a radius of curvature less than 10 nanometres, while what is required is 1 nanometre. Too great a radius of curvature does not lead to exact reconstitution of the shape of the tip on deconvolution between the shape of the contour obtained and the shape of the cavity.

Finally, the rising overhangs are worn as and when they are used for the characterization of tips, and their radii of curvature increase accordingly without this being taken into account when characterizing tips. The increase in the radius of curvature is proportional to the wear, with a slope directly proportional to the sharpness of the tip. This induces additional errors that are not negligible compared to the measured magnitudes.

### SUMMARY OF THE INVENTION

An object of the invention is to provide a characterization tool that greatly reduces these drawbacks, notably providing for complete characterization by only one structure.

To this end there is proposed a tool for the determination of shape and dimensions of atomic force microscope tips, which includes a support plate carrying two separated studs raised relative to the plate and connected by a suspended thin beam the section of which has a known shape and known dimensions.

The thickness of the beam (in the vertical direction) is small relative to the dimensions of the tip to be measured, because it defines the accuracy of the measurement. The height under the beam is at least equal to the length of the tip portion the shape and the dimensions whereof are to be determined. The length of the beam, i.e. in practice the distance between the studs, is sufficient to allow the tip to pass between the studs. The width of the beam must be known in order to characterize the shape of the two sides of a tip of complex shape.

The beam preferably has a rectangular cross section that is constant over the whole of its length between the studs with dimensions that are small relative to the dimensions of the tip to be measured.

The tool preferably includes a series of parallel beams spaced from each other, produced simultaneously, so that a new beam can be used if a previous beam is worn or broken.

The tool is intended to be used
either in an atomic force microscope intended primarily for observation of reliefs and in a subsidiary way for the characterization of tips; in this case it is used during tip characterization operations, in place of an object the relief whereof is to be measured,
or in a device that is intended only for the characterization of tips; in this latter case, the device that uses the tool of the invention is entirely analogous to an atomic force microscope but is used only to observe the beam of known shape using a tip of unknown shape: the device therefore includes all the essential means of an atomic force microscope, namely means for horizontal movement of the tip in an imposed scanning direction perpendicular to the length of the beam, means for vertical suspension of the tip allowing vertical movement thereof in response to contact between the tip and the beam, and means for detecting measuring vertical movements of the tip during the horizontal movements. The detection means are preferably optical.

The studs of the tool are preferably studs of silicon formed on a plate of silicon or silicon carbide. The beam is preferably of silicon.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1, already described, represents the principle of exploration of a relief with two types of tip, depending on the nature of the relief observed;

FIG. 2, already described, represents the principle of reconstitution of a relief shape by deconvolution between a relief curve (2b) obtained and the known shape of the observation tip;

FIG. 3, already described, represents the first step of characterization of a complex tip in the prior art;

FIG. 4, already described, represents the second step of characterization of the complex tip in the prior art;

FIG. 5 represents the principle of the tip shape determination tool of the invention;

FIG. 6 represents phases of increasing wear of the beam from FIG. 5;

FIG. 7 represents examples of tips that can be characterized using the tool of the invention.

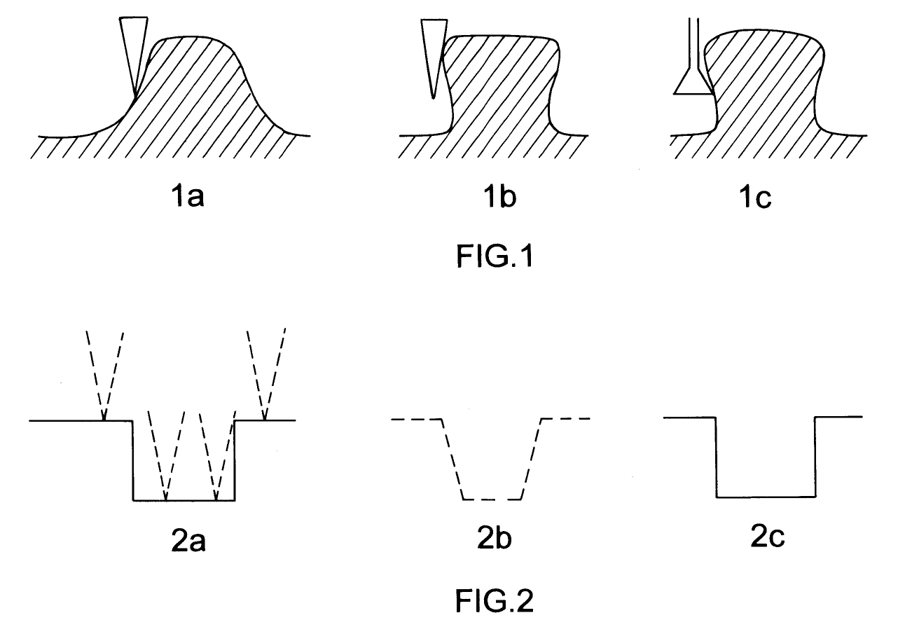

### DETAILED DESCRIPTION OF THE INVENTION

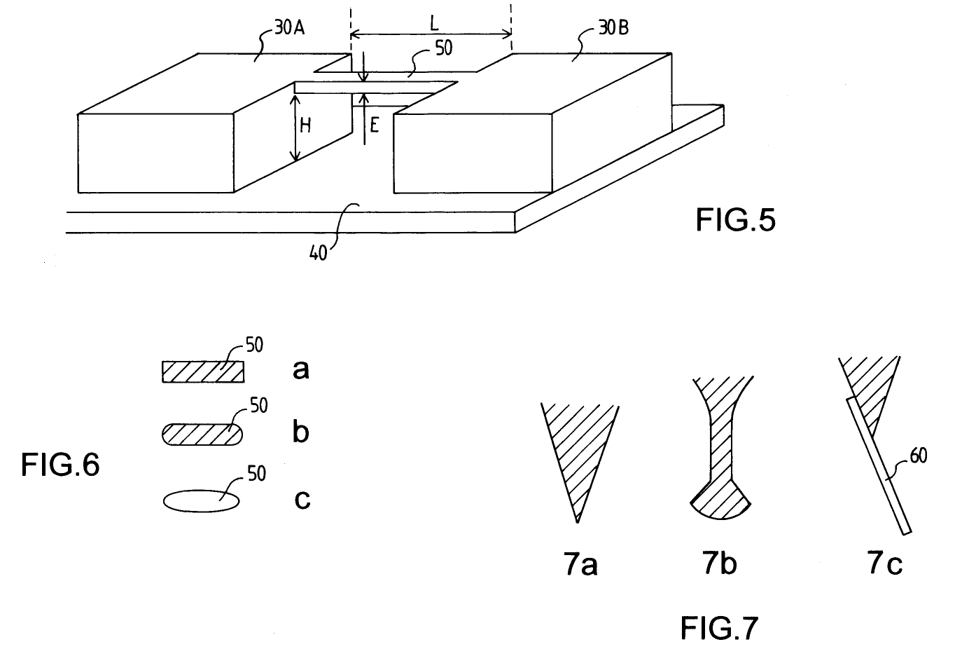

FIG. 5 represents the general principle of the atomic force microscope tip shape determination assistance tool.

The tool essentially consists of
two raised studs 30A and 30B formed on a substrate 40, these studs being separated by an empty space constituting a trench having a width L sufficient for the tip to be characterized to be able to pass between the studs;
a rigid beam 50 of length L and thickness E, built in between the studs, suspended above the substrate, at a height H sufficient for the whole of the tip portion to be characterized to be able to descend below the beam without the tip touching the substrate.

The determination tool is a mechanical structure micromachined by means of processes used in microelectronics (deposition, photolithography, etching, etc.). The dimensions of this structure are very small: the beam notably has an extremely small thickness E, preferably of the order of 5 nanometres. It is in fact this small dimension that can guarantee good characterization of the tips.

The substrate can be of silicon or of silicon carbide. Likewise the studs. The beam is preferably produced in the same material as the studs (notably silicon or silicon carbide) or in a different material, preferably a material commonly used in microelectronics or compatible with the standard microelectronic processes, such as silicon oxide, silicon nitride, titanium nitride, and equally metals such as aluminium or metal alloys such as AlCu.

Very simple processes that are very well mastered can be used to produce the FIG. 5 tool.

For example, the process begins with a monocrystalline silicon substrate that can be covered with a thin layer of silicon oxide (etch stop buffer layer).

Step 1: a uniform layer of monocrystalline silicon with a thickness at least equal to H is deposited epitaxially constitutes most of the studs 30A and 30B. This layer is etched after a photolithography step producing an etching mask that corresponds to the required shape of the studs and their spacing L, which will be the length of the beam. The etching is stopped at the buffer layer. The buffer layer can be eliminated where it is flush with the substrate, i.e. outside the studs. The two studs are obtained on the substrate, separated by a longitudinal trench of width L along which the tip to be characterized can be passed.

Step 2: a layer of a material, preferably silicon oxide, is then deposited to fill the space between the studs. The oxide is deposited in this space and also on top of the studs. The excess oxide on top of the studs is removed (planarization step) to produce a structure in which the top of the studs is flush with (at the same height as) the oxide.

Step 3: a thin layer of silicon is deposited on the uniformly plane assembly, preferably by epitaxial growth so that the silicon obtained is monocrystalline; the thickness of this layer is the required thickness E of the beam 50 to be produced, for example 5 nanometres. This thickness is a compromise so that the beam has sufficient mechanical strength in use, as a beam that is too thin can be too fragile; however, it will be clear that at the same time as complying with this condition, it is desirable for the beam to be as thin as possible, as this guarantees higher measurement accuracy. The layer of silicon then rests both on the oxide and on the studs; it completes the latter as it is attached to them.

Step 4: the second layer of silicon is etched according to a pattern that comprises both the beam with small dimensions resting on the oxide and a wider portion located on top of each of the silicon studs previously formed. The etching is stopped at the oxide. There is obtained in silicon a built-in beam pattern embedded in two portions of silicon attached to the studs previously formed, this beam resting on the silicon oxide.

Step 5: all the oxide located on top of the substrate in the trench between the studs is removed by wet etching using hydrogen fluoride (HF). The built-in beam remains suspended at a height H above the substrate, embedded in studs that consist of the superposed silicon deposited in step 1 and step 3.

The structure is then that from FIG. 5. To characterize an atomic force microscope tip using the determination tool described, the tip to be characterized is moved laterally in the trench of width L situated between the studs. This movement is effected in the longitudinal direction of the trench between the studs, so as to press the tip against the beam 50 (at only one point of contact), and a vertical force is additionally exerted on the tip (as in an atomic force microscope) so that the tip is pressed onto the beam with a calibrated force. The tip to be calibrated is moved both in height and in width so that all points on the tip surface to be characterized are pressed successively against the beam.

The tip characterization device that comprises the shape determination tool represented in FIG. 5 is thus itself an atomic force microscope, or in any event includes all the essential elements thereof, but instead of the tip “observing” a relief to be measured, it “observes” the beam by being pressed against it in all possible ways. During this observation, the successive positions of the tip are logged, in two dimensions (horizontal movement of the tip between the studs, in a direction perpendicular to the beam, and corresponding vertical movement in the heightwise direction between the studs as a function of the position of the point of contact between the tip and the beam) and from this a movement curve is deduced which, because the tip remains at all times in contact with the beam, reflects the shape of the tip. The exact shape can be obtained by deconvolution between the movement curve and the known shape of the beam.

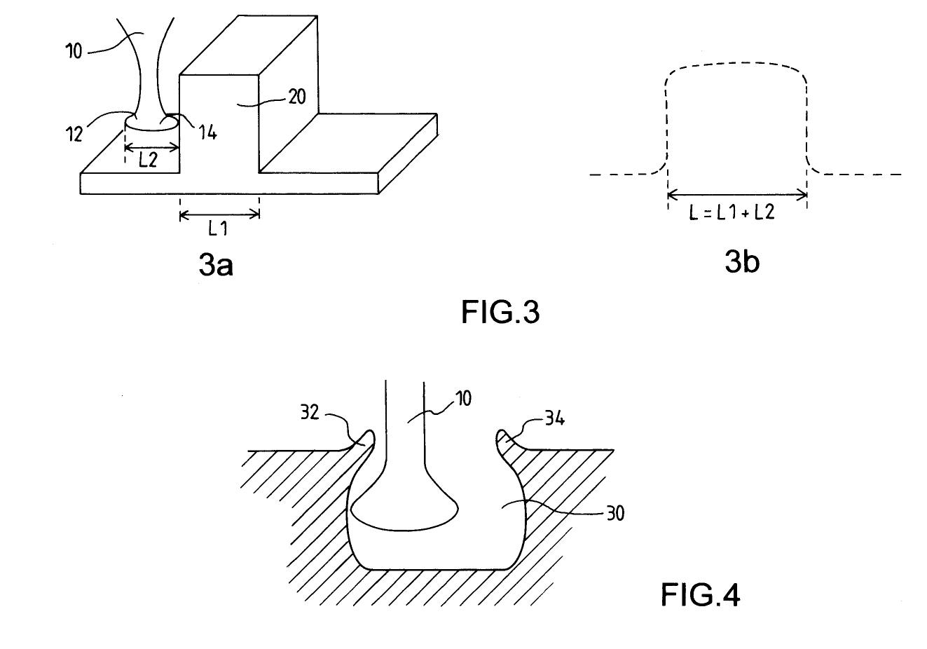

The known shape of the beam can be theoretically treated as a simple plate of quasi-zero thickness and of known width; in this case, deconvolution consists only in taking account of the width of the beam: this width must be subtracted from the curve of the movements produced upon application of the tip to one side and then the other of the beam, as explained with reference to FIG. 3.

The width L of the trench is sufficient to enable the tip to pass between the studs. As already stated, the height H is sufficient for the various portions of the tip to be able to touch the beam without the lower end of the beam touching the substrate.

This tool structure is used for complete determination of the size and the shape of the tip, without it being necessary to use two different tools. Knowing the width of the beam, it is possible to obtain the size of the tip if both sides of the beam are used, the right-hand side of the tip being pressed against the left-hand side of the beam, and vice-versa. The thickness of the beam (vertical heightwise dimension between the studs) is very small and preferably less than 5 nanometres. Because the tip can slide under the beam if it has a complex shape, its shape can be determined completely.

The beam is perfectly horizontal relative to the substrate 40, especially if it is produced as previously indicated by steps of superposing and etching layers the thicknesses whereof are closely controlled in microelectronic techniques. As it wears, the rectangular edge of the section of the beam becomes rounded, which merely increases the accuracy with which the point of contact between the beam and the tip to be characterized is known, as FIG. 6 shows. In FIG. 6 there are seen three states a, b, c of increasing wear of the active edge of the beam, which is represented in cross section perpendicular to its length. Clearly the accuracy with which the point of contact is known is not degraded by wear. Once the wear exceeds a threshold, the beam will naturally break and become unusable. The tool can include a series of adjacent parallel beams, separated by intervals sufficient for the tips to be characterized to pass through them, and a new beam is then used if the previous one breaks.

With the tool of the invention, it is possible to determine the size and the shape of all kinds of simple tips (for example conical tips) or complex tips (flared tips, elephant's foot tips), or tips that have partially deteriorated. FIG. 7 shows examples of tips that can be characterized in this way: degraded simple tip at 7a, complex tip at 7b. The complex tips that can be characterized in this way include tips to the end of which has been grafted a carbon nanotube 60 of extremely small diameter disposed obliquely relative to a vertical axis of the tip (7c).

It is assumed hereinabove that the beam is not deformed on application of a contact force between the tip to be characterized and the beam. It is nevertheless possible to take account of this deformation, which can be calculated if the dimensions of the beam, the material of which it is constituted, and the value of the contact force are known. The value of the contact force can be determined because atomic force microscope type measuring devices, in which this tool can be used, operate in a manner that is based on application of a known contact force, generally by piezoelectric means.

Moreover, the sag of the beam under its own weight is also known, and can be taken into account so as not to introduce any error into the position of the point of contact between the beam and the tip. The weight is very low in practise, however, and can be ignored compared to the force applied by the tip.

Overall, experience shows that deformation of the beam by the force of application of the tip remains very small, especially if the beam is relatively wide, and this deformation has no significant impact on the reproducibility of the measurements.

The tool of the invention is advantageously used in a “tapping” mode, i.e. an oscillating force mode in which the tip oscillates along the vertical axis at a given frequency, exerting a force of the order of ten nanonewtons at each point of contact with the surface being analysed, the tip scanning the horizontal surface. The preferred tapping mode is the critical dimension (CD) mode, in which the tip oscillates at a constant amplitude fixed by the user in the horizontal axis. More details of the tapping mode can be found in the paper “Tip Characterization and Surface Reconstruction of Complex Structures with Critical Dimension Atomic Force Microscopy”, G. Dahlen, M. Osborn, N. Okulan, W. Foreman, A. Chand and J. Foucher, Journal of Vacuum Science & Technology B: Microelectronics and Nanometre Structures—November 2005—Volume 23, Issue 6, pp. 2297-2303.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. Tool for the determination of shape and dimensions of atomic force microscope tips, which includes a support plate carrying two separated studs raised relative to the plate and connected by a suspended thin beam the section of which has a known shape and known dimensions.

2. Tool according to claim 1, wherein the beam is of rectangular cross section and has a thickness that is small relative to the dimensions of the tip to be measured.

3. Tool according to claim 1, wherein the support is a silicon or silicon carbide plate.

4. Tool according to claim 1, wherein the beam and the studs are formed in the same material.

5. Tool according to claim 1, wherein the beam is of silicon.

6. Tool according to claim 1, wherein it includes a series of adjacent parallel beams spaced from each other.

7. Use of the tool according to claim 1, as an atomic force microscope tip characterization tool.

8. Tool according to claim 1, wherein it further includes means for horizontal movement of the tip in an imposed scanning direction perpendicular to the longitudinal direction of the beam, means for vertical suspension of the tip allowing vertical movement thereof in response to contact between the tip and the beam, and means for detecting and measuring vertical movements of the tip during the horizontal movements.
